(19) United States
(12) Patent Application Publication
(10) Pub. No.: US 2025/0231570 A1
(43) Pub. Date: Jul. 17, 2025

(54) GUIDED AUTONOMOUS LANDING SYSTEM FOR AIRCRAFT

(71) Applicant: Textron Innovations Inc., Providence, RI (US)

(72) Inventor: Jeffrey W. Holcomb, Fort Worth, TX (US)

(73) Assignee: Textron Innovations Inc., Providence, RI (US)

(21) Appl. No.: 18/410,872

(22) Filed: Jan. 11, 2024

(51) Int. Cl. G05D 1/654; B64D 45/08; B64F 1/18; G01S 13/91

(52) U.S. Cl. CPC G05D 1/654; B64D 45/08; B64F 1/18; G01S 13/913

(57) ABSTRACT

A landing guidance system for an aircraft is described and includes at least one receiver for installation on the aircraft, the at least one receiver configured to receive signals emitted by a plurality of emitters associated with a landing area; and a processing system for processing the received signals to determine at least one of a location, a distance, an orientation, a configuration, and a geometry of the landing area relative to the aircraft.

### TECHNICAL FIELD

This disclosure relates in general to the field of aircraft and, more particularly, though not exclusively, to systems and techniques for utilizing signals that are configured both spatially and temporally to enable autonomous landing for aircraft, particularly rotorcraft.

### BRIEF DESCRIPTION OF THE DRAWINGS

To provide a more complete understanding of the present disclosure and features and advantages thereof, reference is made to the following description, taken in conjunction with the accompanying figures, in which like reference numerals represent like elements:

FIG. 1 illustrates an example rotorcraft in accordance with features of embodiments described herein;

FIG. 2-5 respectively illustrate examples of guided autonomous landing systems for aircraft in accordance with features of embodiments described herein;

FIGS. 6A and 6B are flowcharts illustrating operations performed in connection with example guided autonomous landing systems for aircraft in accordance with features of embodiments described herein;

FIG. 7 illustrates a system block diagram of an aircraft control system in which an example guided autonomous landing system for aircraft is implemented in accordance with features of embodiments described herein; and

FIG. 8 illustrates an example processor-based system with which some aspects of the embodiments described herein can be implemented.

### DETAILED DESCRIPTION

Rotary-wing aircraft, or rotorcraft, are often required to serve a variety of functions. For example, in some instances, rotorcraft may be required to lift heavy objects and either hover in place or move at a relatively low rate of speed. In other instances, rotorcraft may be required to move at a relatively high rate of speed, particularly when they are not lifting an object or otherwise engaged in stationary flight operations. A feature of some rotorcraft is the ability to operate as a vertical takeoff and landing (VTOL) craft.

There are a variety of scenarios in which VTOL craft, or simply VTOLs, lose visibility. Loss of visibility during landing of the aircraft can create an extremely dangerous situation for aircraft, passengers, and/or ground crew and others. This need for visibility, especially on landing, has been addressed by ground based augmentation systems (GBAS), which augments the existing global positioning system (GPS) used in US airspace by providing corrections to aircraft in the vicinity of an airport or landing pad in order to improve the accuracy of and provide integrity for aircrafts' GPS navigational system. While effective, GBAS is complex and expensive and requires communication with the GPS constellation of satellites. Additionally, GBAS is not suitable for black-out scenarios, in which communication systems are down, and requires power to both airborne and ground-based systems.

In accordance with features of embodiments described herein, a relatively low cost alternative to GBAS and comparable aircraft landing guidance systems may be provided using shaped signal technology. In particular embodiments, a guided autonomous landing system may be implemented using one or more receivers and/or transmitters arranged relative to a landing pad or helipad in such a manner as to enable the aircraft to locate the landing pad. In certain embodiments, as will be described in greater detail below, a low cost solution may be implemented using radio frequency identification (RFID) tags to define and identify to an aircraft a landing area or site. RFID technology enables remote communication between two locations using only a single energy source, such the only powered system is the one that exists on the air platform. As a result, concern over the functionality of the guidance system on the landing pad may be reduced or eliminated. Moreover, RFID tags maybe ruggedized and incorporated into a variety of materials and/or objects. Certain RFID systems may operate at distances of up to 500 meters. In alternative embodiments, as will also be described in detail below, one or more receivers and/or emitters may be installed in association with a landing area to define and identify same to an aircraft.

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming, it would nevertheless be a routine undertaking for those of ordinary skill in the art having the benefit of this disclosure.

In the specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above,” “below,” “upper,” “lower,” or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction.

Further, the present disclosure may repeat reference numerals and/or letters in the various examples. This repetition is for the purpose of simplicity and clarity and does not in itself dictate a relationship between the various embodiments and/or configurations discussed.

Example embodiments that may be used to implement the features and functionality of this disclosure will now be described with more particular reference to the attached figures.

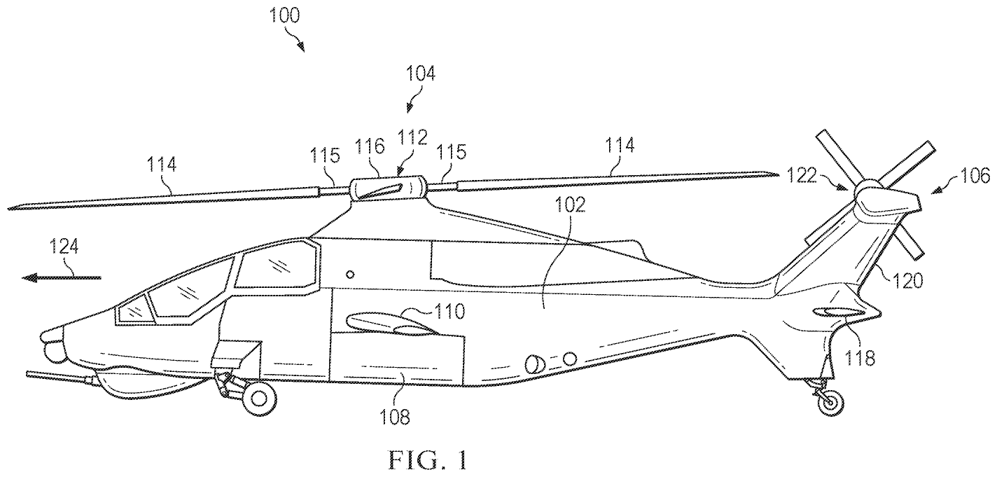

FIG. 1 illustrates a side view of an example aircraft, which in the illustrated example is a rotorcraft 100. As shown in FIG. 1, rotorcraft 100 includes a fuselage 102, a primary rotor system 104, and an empennage 106. The fuselage 102 is the main body of the rotorcraft 100, which may include a cabin (e.g., for crew, passengers, and/or cargo) and/or may house certain mechanical components, electrical components, etc. (e.g., engine(s), transmission, flight controls, etc.). In accordance with features of particular embodiments, the fuselage 102 can also include a payload bay covered by a payload bay door 108 disposed under a wing 110, which in some embodiments includes a support structure and actuation mechanism for extending externally stowed payload (e.g., weapons) outboard away from the fuselage 102 to a firing position.

The primary rotor system 104 is used to generate lift for rotorcraft 100. For example, the primary rotor system 104 (also generally referred to as the “rotor”) may include a rotor hub 112 (also referred to as a “rotor hub assembly” or more generally as a “hub”) coupled to a plurality of rotor blades 114 (also referred to generally as “blades”). Torque generated by the engine(s) of the rotorcraft causes the rotor blades 114 to rotate, which generates lift. The empennage 106 of the rotorcraft 100 includes a horizontal stabilizer 118, a vertical stabilizer 120, and a tail rotor or anti-torque system 122. Although not shown in the view illustrated in FIG. 1, a corresponding horizontal stabilizer is disposed on the other side of the rotorcraft 100 opposite the horizontal stabilizer 118. The horizontal stabilizer 118 and vertical stabilizer 120 respectively provide horizontal and vertical stability for the rotorcraft 100. Moreover, tail rotor or anti-torque system 122 may be used to provide anti-torque and/or direction control for the rotorcraft 100.

Rotorcraft 100 relies on rotor system 104 for flight capabilities, such as controlling (e.g., managing and/or adjusting) flight direction, thrust, and lift of the rotorcraft. For example, the pitch of each rotor blade 114 can be controlled using collective control or cyclic control to selectively control direction, thrust, and lift of the rotorcraft 100. During collective control, all the of rotor blades 114 are collectively pitched (i.e., the pitch angle is the same for all blades), which effects overall thrust and lift. During cyclic control, the pitch angle of each of the rotor blades 114 varies depending on where each blade is within a cycle of rotation (e.g., at some points in the rotation the pitch angle is not the same for all blades), which can affect direction of travel of the rotorcraft 100.

Aircraft such as rotorcraft 100 can be subjected to various aerodynamic and operational forces during operation, such as lift, drag, centrifugal force, aerodynamic shears, and so forth. Lift and centrifugal force, for example, are forces produced by the rotation of a rotor system. Lift is an upward force that allows a rotorcraft to elevate, while centrifugal force is a lateral force that tends to pull the rotor blades outward from the rotor hub. These forces can subject the rotor hub, rotor yoke, and/or the rotor blades (referred to herein using the terms “hub/blades,” “yoke/blades,” “hub/yoke/blades,” and variations thereof) to flapping, leading and lagging, and/or bending. For example, flapping is a result of the dissymmetry of lift produced by rotor blades at different positions (typically referred to as “pitch” or “pitch angles”) during a single rotation. During rotation, for example, a rotor blade may generate more lift while advancing in the direction of travel of the rotorcraft than while retreating in the opposite direction. A rotor blade may be flapped up (also sometimes referred to as being pitched “nose-up”) while advancing in the direction of travel, and may flap down (e.g., pitched “nose-down”) while retreating in the opposite direction. When a blade is pitched more nose-up, more lift is created on that blade, which will drag the side of the rotor/hub upward, which makes the hub/yoke flap. For example, for rotorcraft 100, the most aft blade (e.g., nearest to tail rotor or anti-torque system 122) of the rotor system 104 may be pitched more nose-up and the most forward blade may be pitched more nose-down; to provide a forward direction of travel (as generally indicated by arrow 124) for rotorcraft 100.

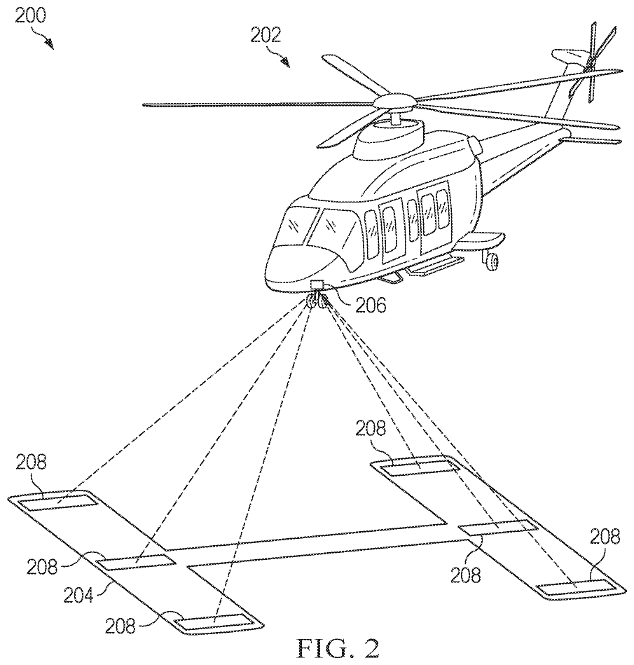

Referring now to FIG. 2, in accordance with features of embodiments described herein, a guided autonomous landing system 200 may be implemented using emitters arranged in a pattern, spatial position, and/or orientation that is known to aircraft, such as aircraft 202, to create a geometric signal, or beacon, pattern that can be utilized by aircraft to triangulate or otherwise determine the position of a helipad or other landing site, represented in FIG. 2 by a helipad 204. It will be recognized that the emitters incorporated into particular embodiments described herein may be integrated into sensors; therefore, as used in this document, the term sensor may be deemed to refer to a sensing device that includes an integrated emitter as appropriate.

RFID is a wireless technology implemented using two types of components, including tags and readers. Readers may include one or more antennas that emit radio waves and receive signals back from RFID tags. Tags, which may use radio waves to communicate their identity and other information to nearby readers, may be passive or active. Passive RFID tags are powered by a reader and do not have a battery (i.e., passive tags may be referred to as “unpowered”). Active RFID tags are powered by batteries and may be referred to as “powered.” Active RFID tags may further include a transmitter in the form of a beacon or a transponder. RFID tags can store a range of information from a single serial number and/or other identification information to several pages of data.

As will be described in greater detail hereinbelow, in accordance with particular embodiments, system 200 includes one or more emitter/receiver devices represented in FIG. 2 by a device 206, installed on or otherwise incorporated into or onto aircraft 202 and one or more emitters or sensors 208 embedded in or otherwise associated with helipad 204. In accordance with features of embodiments described herein, sensors 208 are positioned with respect to helipad 204 in a particular known arrangement or configuration. As shown in FIG. 2, for example, sensors 208 may be said to be arranged in an “H” (or “I”) configuration, although other numbers and configurations of sensors may be provided without departing from the spirit or scope of embodiments described herein.

As used herein, the term sensors may include any number of different types of devices for emitting and/or receiving electromagnetic waves, or signals, in accordance with features of embodiments described herein. It should be recognized that dashed lines between sensors 208 and device 206 are intended to represent emission of signals between the devices, they are not intended as an accurate or literal representation of the emission patterns of any of the devices. In particular embodiments described herein, guided autonomous landing systems may be implemented using radio frequency signals and/or light frequency (i.e., infrared (IR), visible, and or ultraviolet (UV)) signals, although other types of electromagnetic signals may be used without departing from the spirit or scope of the disclosure. In some embodiments, sensors associated with a single landing site may emit the same type of signals. In other embodiments, sensors associated with a single landing site may emit different types of signals. Moreover, although for ease of example and simplicity, embodiments are described herein as comprising radio frequency emitters, it will be recognized that light emitters, such as light emitting diodes, may be advantageously employed in particular embodiments.

As will be further described herein, sensors 208 may be implemented using devices that may constantly emit signals for detection by device 206; alternatively, sensors 208 may be implemented using devices that they only emit signals in response to a stimulus (e.g., a query signal emitted from device 206). As such, sensors 208 may be implemented using active devices (i.e., devices that have their own internal power source) or passive devices (i.e., devices that do not have an internal power source).

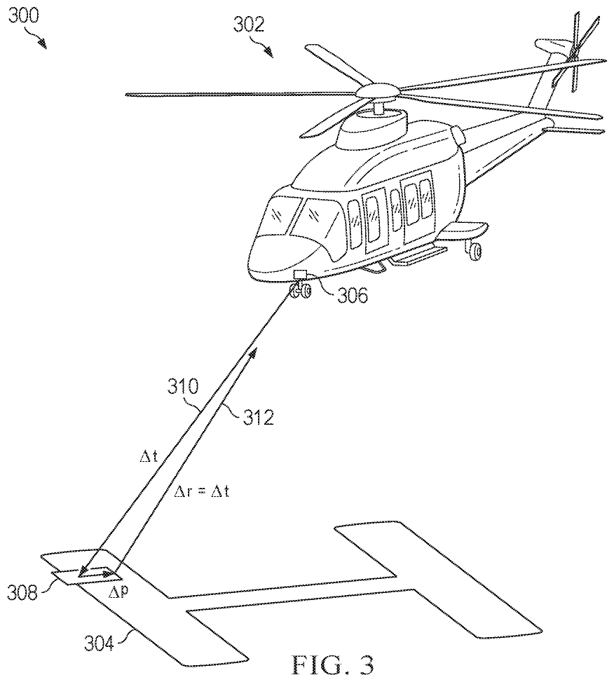

Referring now to FIG. 3, illustrated therein is a guided autonomous landing system 300 that may be implemented using passive emitters to create a geometric signal pattern that can be utilized by aircraft, such as an aircraft 302, to triangulate the position of a helipad or other landing site, represented in FIG. 3 by a helipad 304. Similar to system 200, system 300 includes one or more transmitter/receiver devices, represented in FIG. 3 by device 306, installed on or otherwise incorporated into or onto aircraft 302 and one or more sensors, represented in FIG. 3 by a sensor 308, embedded in or otherwise associated with helipad 304. Similar to the embodiment shown in and described with reference to FIG. 2, sensors of system 300 (represented by sensor 308) may be positioned with respect to helipad 304 in a particular known arrangement or configuration. In some embodiments, device 306 may be implemented as an RFID reader and sensors, such as sensor 308, may be implemented using RFID tags.

In the embodiment illustrated in FIG. 3, in operation, a query signal 310 may be emitted from device 306. As illustrated in FIG. 3, assuming query signal 310 is emitted at a time t=0 seconds, the signal is received at sensor 308 at a time t=Δt, such that Δt may be defined as the transmission delay of the query signal. After a processing delay of Δp to account for processing of the signal 310 at sensor 308, a response signal 312 is returned from the sensor 308 to device 306. The time that elapses between transmission of the response signal 312 by the sensor 308 and receipt thereof by device 306 is defined as the response delay Δr, which in some embodiments (including the one illustrated in FIG. 3) is presumed to be equal to the transmission delay Δt.

Assuming Δp is a known quantity, then:

Δt=(round trip time−Δp)/2

Therefore, a distance d between device 306 and sensor 308 is defined as:

d=c((round trip time−Δp)/2),
where c is defined as the speed of light (i.e., 299,792,458 meters/second).

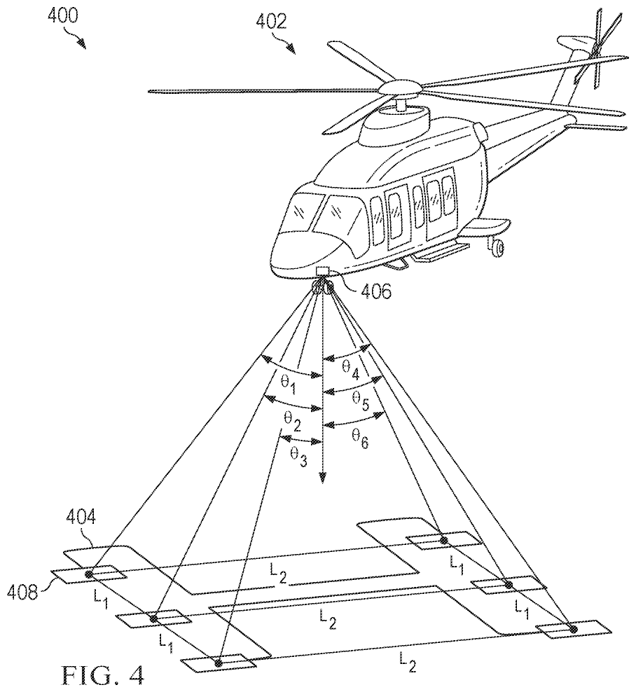

Referring now to FIG. 4, illustrated therein is a guided autonomous landing system 400 that may be implemented using active emitters to create a geometric signal pattern that can be utilized by aircraft, such as an aircraft 402, to triangulate the position of a helipad or other landing site, represented in FIG. 4A by a helipad 404. Similar to systems 200 and 300, system 400 includes transmitter/receiver devices, represented by a device 406, installed on or otherwise incorporated into or onto aircraft 402 and sensors, or emitters, 408 embedded in or otherwise associated with helipad 404. Sensors 408 may be positioned with respect to helipad 404 in a particular known arrangement or configuration. As shown in FIG. 4, for example, sensors 408 may be said to be arranged in an “H” (or “I”) configuration, although other numbers and configurations of sensors may be provided without departing from the spirit or scope of embodiments described herein.

In system 400, sensors 408 are implemented using active (i.e., powered) emitters, which allow for higher resolution at greater distances. As shown in FIG. 4, the layout of sensors 408 and the chirp signal specifications thereof may be standardized. Alternatively, the chirp signal(s) can be calibrated to convey information about the physical geometry of the sensor layout relative to helipad 404. The distance to a helipad in which active emitters are used, such as helipad 404 with sensors 408, can be determined using template matching methods. Additionally and/or alternatively, the geometry of the sensor layout can be conveyed to the device 408 via chirp signals from sensors. Still further, the a priori known emitter IDs can be encoded into the chirp signal to enable extraction of more accurate layout information. Use of such a method assumes that the ground sensors (e.g., sensors 408) are either constantly emitting or are responding in unison to response to a single receiver (e.g., device 406).

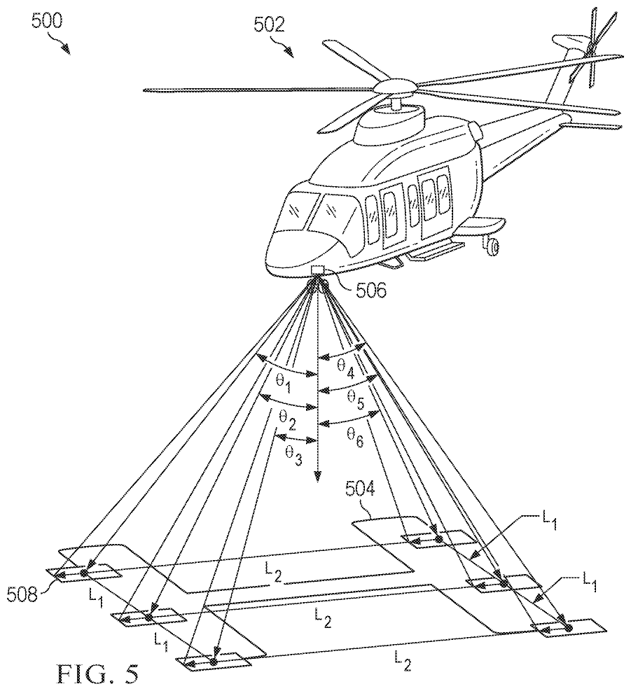

Referring now to FIG. 5, illustrated therein is an example guided autonomous landing system 500 that may be implemented using emitters to create a geometric signal pattern that can be utilized by aircraft, such as an aircraft 502, to triangulate the position of a helipad or other landing site, represented in FIG. 5 by a helipad 504. Similar to systems 200, 300, and 400, system 500 includes one or more transmitter/receiver devices, represented in FIG. 5 by device 506, installed on or otherwise incorporated into or onto aircraft 502 and sensors 508 embedded in or otherwise associated with helipad 504. Sensors 508 may be positioned with respect to helipad 504 in a particular known arrangement or configuration.

In the embodiment illustrated in FIG. 5, sensors 508 may include a combination of active and passive sensors, such that each sensor 508 responds to a query signal with a predictable delay. In this embodiment, time-of-flight information can be combined with direction finding information and template matching may still be used. Device 506 may further include one or more of light detection and ranging (LIDAR), laser detection and ranging (LADAR), and/or radio detection and ranging (RADAR) sensors, the addition of which may enable further distance accuracy to be achieved, assuming a degraded visual environment (DVE) is not an issue. Optical emitters, such as LEDs, may be leveraged with one or more sensors 508 for emitting light signals for received by one or more appropriate receivers comprising device 506 for further increasing system accuracy and/or confidence.

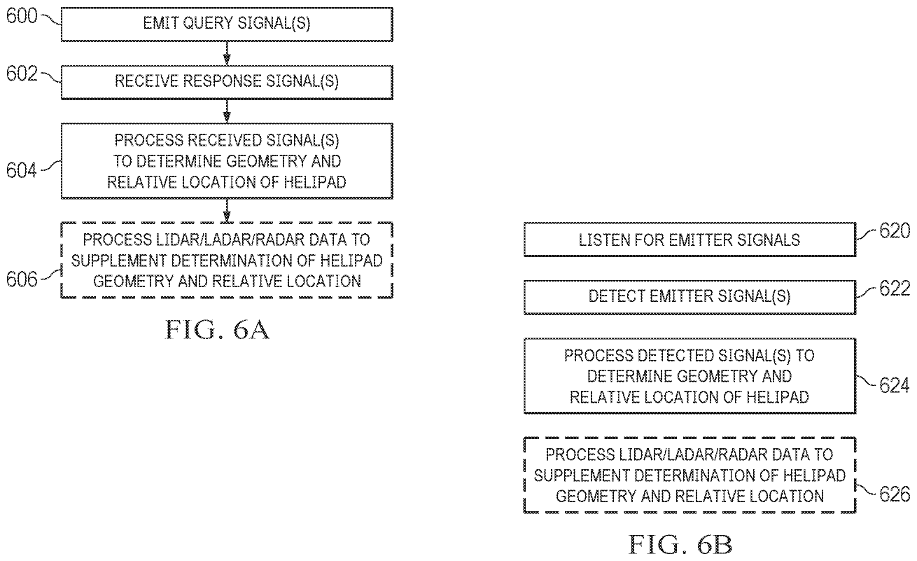

FIG. 6A is a flowchart of operations that may be performed in connection with an autonomous guided landing system according to particular embodiments. In operation 600, one or more query signals are emitted by one or more emitter devices installed on an aircraft, such as a rotorcraft. Depending on the configuration, query signal(s) may be emitted constantly or may be emitted in response to a trigger (e.g., a determination based on GPS analysis or travel time, for example, that aircraft should be in the vicinity of a helipad). As described above, query signal(s) are received by one or more ground sensors, each of which emits a response signal to the device(s) installed on the aircraft in operation 602. Response signals emitted by emitters may uniquely identify the emitter and may provide additional information, such as an absolute or relative location of the emitter, a configuration of the landing site, a size of the landing site, and/or an orientation of the landing site, for example.

In operation 604, the received response signals are processed to determine a location, distance, orientation, configuration, and/or geometry of the landing site relative to the aircraft. In accordance with features of particular embodiments, as noted above, the response signals may include information that identify the sensor that emitted the signal in order to aid in the signal processing performed in operation 604. In addition to template matching and emitter ID recognition methods that can be used to understand what emitters are on the ground and where they are located relative to the aircraft and to one another, the Direction of Arrival (DoA) for the response signals can be determined using sparse array methods, Beamscan methods, MVDR, MUSIC, root-MUSIC, ESPRIT, root-WSF, generalized cross correlation methods and other methods related to determining the DoA for an ambient RF signal.

In optional operation 606, RADAR, LADAR, and LIDAR data may be used to supplement and/or confirm/correct the determination made in operation 604 concerning the location, distance, and/or geometry of the helipad.

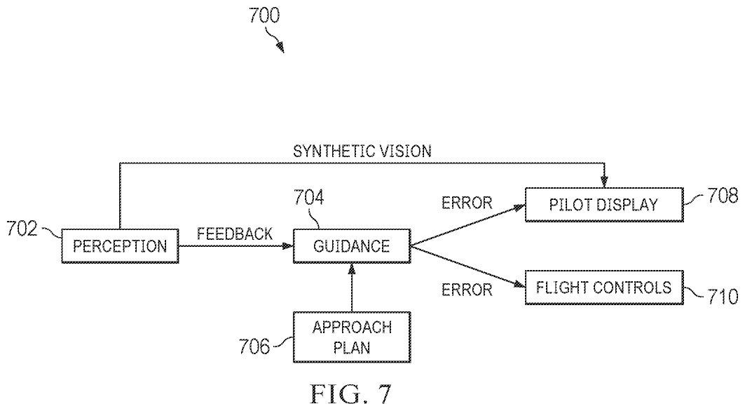

Once determined (and corrected/confirmed, if applicable), the location, distance, orientation, configuration, and/or geometry of the landing site relative to the aircraft made available to other systems of the aircraft as described in greater detail below with reference to FIG. 7.

FIG. 6B is a flowchart of operations that may be performed in connection with an autonomous guided landing system according to alterative embodiments. In operation 620, one or more receiver devices installed on an aircraft, such as a rotorcraft, listens for signals emitted by one or more emitters associated with a landing site. In some embodiments, receiver devices are constantly listening for such signals. In alternative embodiments, operation 620 is triggered by occurrence of an event, such as a determination that aircraft should be approaching or in the proximity of a known landing site according to a flight plan, for example.

In operation 622, one or more signals emitted by the one or more emitters associated with the landing site are received by the one or more receiver devices. As previously noted, the signal emitted by an emitter may uniquely identify the emitter and may provide additional information, such as an absolute or relative location of the emitter, a configuration of the landing site, a size of the landing site, and/or an orientation of the landing site, for example.

In operation 624, the received emitter signals are processed to determine a location, distance, orientation, configuration, and/or geometry of the landing site relative to the aircraft. In accordance with features of particular embodiments, as noted above, the response signals may include information that identify the sensor that emitted the signal in order to aid in the signal processing performed in operation 624. In addition to template matching and emitter ID recognition methods that can be used to understand what emitters are on the ground, the Direction of Arrival (DoA) for the response signals can be determined using sparse array methods, Beamscan methods, MVDR, MUSIC, root-MUSIC, ESPRIT, root-WSF, generalized cross correlation methods and other methods related to determining the DoA for an ambient RF signal.

In optional operation 626, RADAR, LADAR, and LIDAR data may be used to supplement and/or confirm/correct the determination made in operation 604 concerning the location, distance, and/or geometry of the helipad.

Once determined (and corrected/confirmed, if applicable), the location, distance, orientation, configuration, and/or geometry of the landing site relative to the aircraft made available to other systems of the aircraft as described in greater detail below with reference to FIG. 7.

FIG. 7 illustrates a system block diagram of an aircraft control system 700 in which an example guided autonomous landing system for aircraft is implemented in accordance with features of embodiments described herein. Referring to FIG. 7, system 700 includes a perception system 702, which determines a location, distance and/or geometry of a helipad as described in detail above and provides the information as feedback to a guidance system 704. Guidance system 704 processes the received feedback in view of an approach plan 706 to determine a difference between the two sources of information and provides the difference as error information to a pilot display 708 and/or flight controls 710 for use in controlling operation of the aircraft. Additionally and/or alternatively, perception system 702 may provide synthetic vision information to pilot display 708 such that the determined location, distance and/or geometry information may be represented on the display 708 based on the information. It will be recognized that one or more of the elements illustrated in FIG. 7 may be omitted from system 700 and/or additional elements may be included in the system 700 without departing from the spirit or scope of embodiments described herein. In particular embodiments, one or more of the elements shown in FIG. 7 may be implemented using machine learning (ML) and/or artificial intelligence (AI) techniques.

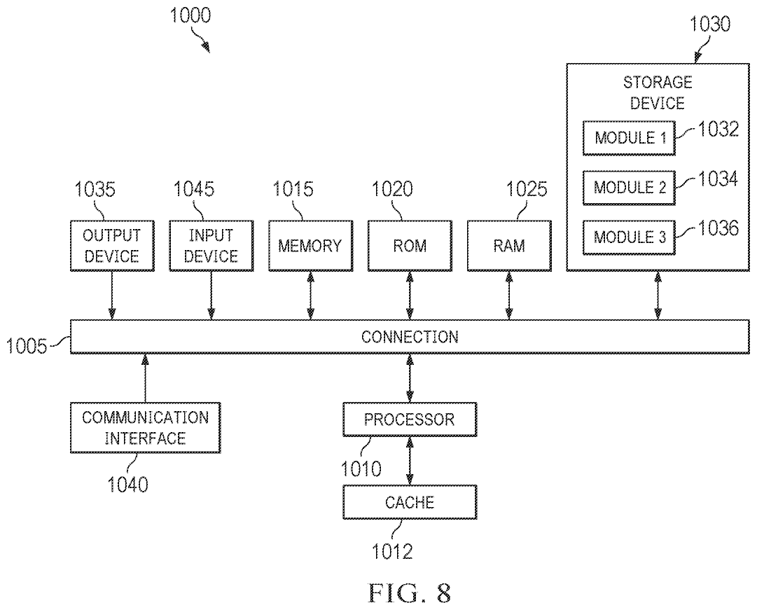

FIG. 8 illustrates an example processor-based system with which some aspects of embodiments described herein can be implemented. For example, processor-based system 1000 can be any computing device making up, or any component thereof in which the components of the system are in communication with each other using connection 1005. Connection 1005 can be a physical connection via a bus, or a direct connection into processor 1010, such as in a chipset architecture. Connection 1005 can also be a virtual connection, networked connection, or logical connection.

In some embodiments, computing system 1000 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1000 includes at least one processing unit (Central Processing Unit (CPU) or processor) 1010 and connection 1005 that couples various system components including system memory 1015, such as Read-Only Memory (ROM) 1020 and Random-Access Memory (RAM) 1025 to processor 1010. Computing system 1000 can include a cache of high-speed memory 1012 connected directly with, in close proximity to, or integrated as part of processor 1010.

Processor 1010 can include any general purpose processor and a hardware service or software service, such as services 1032, 1034, and 1036 stored in storage device 1030, configured to control processor 1010 as well as a special purpose processor where software instructions are incorporated into the actual processor design. One or more of services 1032, 1034, and 1036 may be involved in implementing one or more operations shown and described herein. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms known to those of skill in the art. In some instances, multimodal systems can enable a user to provide multiple types of input/output to communicate with computing system 1000. Computing system 1000 can include communications interface 1040, which can generally govern and manage the user input and system output. The communication interface may perform or facilitate receipt and/or transmission wired or wireless communications via wired and/or wireless transceivers, including those making use of an audio jack/plug, a microphone jack/plug, a USB port/plug, an Apple® Lightning® port/plug, an Ethernet port/plug, a fiber optic port/plug, a proprietary wired port/plug, a Bluetooth® wireless signal transfer, a Bluetooth® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, WLAN signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 1040 may also include one or more GNSS receivers or transceivers that are used to determine a location of the computing system 1000 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 can be a non-volatile and/or non-transitory and/or computer-readable memory device and can be a hard disk or other types of computer-readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid state memory, a Compact Disc Read-Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Static RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 1030 can include software services, servers, services, etc., that when the code that defines such software is executed by the processor 1010, it causes the system 1000 to perform a function. In some embodiments, a hardware service that performs a particular function can include the software component stored in a computer-readable medium in connection with the necessary hardware components, such as processor 1010, connection 1005, output device 1035, etc., to carry out the function.

Example 1 provides a landing guidance system for an aircraft, the landing guidance system including at least one receiver for installation on the aircraft, the at least one receiver configured to receive signals emitted by a plurality of emitters associated with a landing area; and a processing system for processing the received signals to determine at least one of a location, a distance, an orientation, a configuration, and a geometry of the landing area relative to the aircraft.

Example 2 provides the landing guidance system of example 1, in which the at least one receiver is further configured to emit at least one query signal for causing the plurality of emitters to emit the received signals.

Example 3 provides the landing guidance system of example 1 or 2, in which the at least one receiver includes a radio frequency identification RFID reader.

Example 4 provides the landing guidance system of any one of examples 1-3, in which at least one of the plurality of emitters includes a radio frequency identification (RFID) tag.

Example 5 provides the landing guidance system of example 4, in which the RFID tag includes an active RFID tag.

Example 6 provides the landing guidance system of example 4 or 5, in which the RFID tag includes a passive RFID tag.

Example 7 provides the landing guidance system of any one of examples 1-6, in which at least one of the plurality of emitters includes a light emitting diode.

Example 8 provides the landing guidance system of any one of examples 1-7, in which the plurality of emitters are arranged in a configuration relative to the landing area and in which the configuration is known to the guided landing system.

Example 9 provides the landing guidance system of any one of examples 1-8, further including a sensor system including at least one of a light detection and ranging (LIDAR) sensor, a laser detection and ranging (LADAR) sensor, and a radio detection and ranging (RADAR) sensor, in which sensor signals generated by the sensor system are processed by the processing system to confirm or correct the determined at least one of the location, the distance, the orientation, the configuration, and the geometry of the landing area relative to the aircraft.

Example 10 provides a control system for an aircraft, the control system including a perception system including a receiver installed on the aircraft, in which the receiver is configured to emit a query signal and to receive response signals emitted by a plurality of emitters associated with a landing pad in response to the query signal, in which the received response signals are processed by the perception system to determine at least one of a location, a distance, an orientation, a configuration, and a geometry of the landing pad; and a display system for displaying a virtual representation of the determined at least one of the location, the distance, the orientation, the configuration, and the geometry of the landing pad.

Example 11 provides the control system of example 10 further including a guidance system configured to: receive from the perception system feedback including the determined at least one of the location, the distance, the orientation, the configuration, and the geometry of the landing pad; compare the received feedback with a predetermined approach plan for the aircraft to determine a difference therebetween; and provide the determined difference to at least one of a flight control system and a pilot display system for controlling operation of the aircraft.

Example 12 provides the control system of example 10 or 11, in which the receiver includes a radio frequency identification reader.

Example 13 provides the control system of any one of examples 10-12, in which the plurality of emitters include at least one of radio frequency identification tags and light emitting diodes (LEDs).

Example 14 provides the control system of any one of examples 10-13, in which for each of the received response signals, the received response signal identifies which one of the plurality of emitters emitted the received response signal and in which the perception system processes the received signals using triangulation techniques.

Example 15 provides the control system of any one of examples 10-14, in which the plurality of emitters are arranged in a configuration relative to the landing pad, in which the configuration is known to the guided landing system.

Example 16 provides the control system of any one of examples 10-15, further including at least one of a light detection and ranging (LIDAR) sensor, a laser detection and ranging (LADAR) sensor, and a radio detection and ranging (RADAR) sensor, in which sensor signals generated by the sensor system are processed by the perception system to confirm or correct the determined at least one of the location, the distance, the orientation, the configuration, and the geometry of the landing area relative to the aircraft.

Example 17 provides a method for providing a landing guidance system for an aircraft, in which the aircraft has installed thereon a receiver device, the method including receiving by the receiver a signal emitted by an emitter associated with a landing area, in which the received signal includes information for identifying at least one of a location, a distance, an orientation, a configuration, and a geometry of the landing area relative to the aircraft; and processing the received signal to determine feedback including the at least one of the location, the distance, the orientation, the configuration, and the geometry of the landing area relative to the aircraft.

Example 18 provides the method of example 17, further including, prior to the receiving, emitting by the receiver at least one query signal for triggering the emitter to emit the received signal.

Example 19 provides the method of example 17 or 18, further including comparing the feedback with a predetermined approach plan for the aircraft to determine a difference therebetween; and providing the determined difference to at least one of a flight control system and a pilot display system for controlling operation of the aircraft.

Example 20 provides the method of any one of examples 17-19, further displaying on a pilot display system a virtual representation of the landing area based on the determined feedback.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network personal computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The diagrams in the FIGURES illustrate the architecture, functionality, and operation of possible implementations of various embodiments of the present disclosure. It should also be noted that, in some alternative implementations, the function(s) associated with particular FIGURES may occur out of the order presented. For example, two blocks shown in succession may, in fact, be executed substantially concurrently, or the blocks may sometimes be executed in the reverse order or alternative orders, depending upon the functionality involved.

Although several embodiments have been illustrated and described in detail, numerous other changes, substitutions, variations, alterations, and/or modifications are possible without departing from the spirit and scope of the present invention, as defined by the appended claims. The particular embodiments described herein are illustrative only and may be modified and practiced in different but equivalent manners, as would be apparent to those of ordinary skill in the art having the benefit of the teachings herein. Those of ordinary skill in the art would appreciate that the present disclosure may be readily used as a basis for designing or modifying other embodiments for carrying out the same purposes and/or achieving the same advantages of the embodiments introduced herein. For example, certain embodiments may be implemented using more, less, and/or other components than those described herein. Moreover, in certain embodiments, some components may be implemented separately, consolidated into one or more integrated components, and/or omitted. Similarly, methods associated with certain embodiments may be implemented using more, less, and/or other steps than those described herein, and their steps may be performed in any suitable order.

What is claimed is:

1. A landing guidance system for an aircraft, the landing guidance system comprising:
at least one receiver for installation on the aircraft, the at least one receiver configured to receive signals emitted by a plurality of emitters associated with a landing area; and
a processing system for processing the received signals to determine at least one of a location, a distance, an orientation, a configuration, and a geometry of the landing area relative to the aircraft.

2. The landing guidance system of claim 1, wherein the at least one receiver is further configured to emit at least one query signal for causing the plurality of emitters to emit the received signals.

3. The landing guidance system of claim 1, wherein the at least one receiver comprises a radio frequency identification RFID reader.

4. The landing guidance system of claim 1, wherein at least one of the plurality of emitters comprises a radio frequency identification (RFID) tag.

5. The landing guidance system of claim 4, wherein the RFID tag comprises an active RFID tag.

6. The landing guidance system of claim 4, wherein the RFID tag comprises a passive RFID tag.

7. The landing guidance system of claim 1, wherein at least one of the plurality of emitters comprises a light emitting diode.

8. The landing guidance system of claim 1, wherein the plurality of emitters are arranged in a configuration relative to the landing area and wherein the configuration is known to the guided landing system.

9. The landing guidance system of claim 1, further comprising a sensor system including at least one of a light detection and ranging (LIDAR) sensor, a laser detection and ranging (LADAR) sensor, and a radio detection and ranging (RADAR) sensor, wherein sensor signals generated by the sensor system are processed by the processing system to confirm or correct the determined at least one of the location, the distance, the orientation, the configuration, and the geometry of the landing area relative to the aircraft.

10. A control system for an aircraft, the control system comprising:
a perception system comprising a receiver installed on the aircraft, wherein the receiver is configured to emit a query signal and to receive response signals emitted by a plurality of emitters associated with a landing pad in response to the query signal, wherein the received response signals are processed by the perception system to determine at least one of a location, a distance, an orientation, a configuration, and a geometry of the landing pad; and
a display system for displaying a virtual representation of the determined at least one of the location, the distance, the orientation, the configuration, and the geometry of the landing pad.

11. The control system of claim 10 further comprising a guidance system configured to:
receive from the perception system feedback comprising the determined at least one of the location, the distance, the orientation, the configuration, and the geometry of the landing pad;
compare the received feedback with a predetermined approach plan for the aircraft to determine a difference therebetween; and
provide the determined difference to at least one of a flight control system and a pilot display system for controlling operation of the aircraft.

12. The control system of claim 10, wherein the receiver comprises a radio frequency identification reader.

13. The control system of claim 10, wherein the plurality of emitters comprise at least one of radio frequency identification tags and light emitting diodes (LEDs).

14. The control system of claim 10, wherein for each of the received response signals, the received response signal identifies which one of the plurality of emitters emitted the received response signal and wherein the perception system processes the received signals using triangulation techniques.

15. The control system of claim 10, wherein the plurality of emitters are arranged in a configuration relative to the landing pad, wherein the configuration is known to the guided landing system.

16. The control system of claim 10, further comprising at least one of a light detection and ranging (LIDAR) sensor, a laser detection and ranging (LADAR) sensor, and a radio detection and ranging (RADAR) sensor, wherein sensor signals generated by the sensor system are processed by the perception system to confirm or correct the determined at least one of the location, the distance, the orientation, the configuration, and the geometry of the landing area relative to the aircraft.

17. A method for providing a landing guidance system for an aircraft, wherein the aircraft has installed thereon a receiver device, the method comprising:
receiving by the receiver a signal emitted by an emitter associated with a landing area, wherein the received signal comprises information for identifying at least one of a location, a distance, an orientation, a configuration, and a geometry of the landing area relative to the aircraft; and
processing the received signal to determine feedback comprising the at least one of the location, the distance, the orientation, the configuration, and the geometry of the landing area relative to the aircraft.

18. The method of claim 17, further comprising, prior to the receiving, emitting by the receiver at least one query signal for triggering the emitter to emit the received signal.

19. The method of claim 17, further comprising:
comparing the feedback with a predetermined approach plan for the aircraft to determine a difference therebetween; and
providing the determined difference to at least one of a flight control system and a pilot display system for controlling operation of the aircraft.

20. The method of claim 17, further displaying on a pilot display system a virtual representation of the landing area based on the determined feedback.
